(19) United States
(12) Patent Application Publication
(10) Pub. No.: US 2005/0129891 A1
(43) Pub. Date: Jun. 16, 2005

(54) Multi-layer plastic pipe produced by means of rotational casting

(76) Inventor: Josef Knauder, Villach (AT)

Correspondence Address: KUSNER & JAFFE;HIGHLAND PLACE SUITE 310, 6151 WILSON MILLS ROAD, HIGHLAND HEIGHTS, OH, 44143, US

(21) Appl. No.: 10/503,534

(22) PCT Filed: Dec. 13, 2002
(86) PCT No.: PCT/EP02/14178

(30) Foreign Application Priority Data
Feb. 8, 2002 (DE) 102 05 191.7

(51) Int. Cl. B32B 1/08

(52) U.S. Cl. 428/36.91

(57) ABSTRACT

The invention relates to a multi-layer plastic pipe which is produced by means of rotational casting.

The invention relates to a multilayer plastic pipe produced according to the centrifugal moulding process. Plastic pipes produced according to the centrifugal moulding process and methods for their production are for example described in EP 360 758 A2 and CH 684 326 A5.

DE 21 09 643 A describes a method for producing cylindrical hollow bodies, such as pipes, in a rotating mould, wherein the raw materials such as resin are applied by way of nozzles so as to form a layer. An essentially similar method is mentioned in EP 0 533 482 A1.

For the purpose of forming individual layers, various resin mixtures and/or fillers are fed to a rotating mould (die). The design of individual layers and their thickness depends on the intended application. Although curing of the resins used is an exothermal process, it is necessary to feed heat to the system so as to accelerate the curing reaction with the objective of increasing productivity. Nonetheless, evaporation of monomers from the resin mixture can occur.

Although the production method described above and the pipes made according to this method have for example in the field of waste water engineering not only proven reliable, but also been successful in displacing stoneware pipes or concrete pipes, there is a desire to simplify the production technology, to keep the environmental impact as low as possible, and to reduce costs.

In order to achieve this objective, the invention provides for at least partially avoiding the described curing of the resin by heat and using a resin which is curable by light of a specific wavelength.

Curing of resins by exposure to light can take place with visible light or light near the infrared spectrum. To the extent that the layer to be cured comprises a more or less pure resin mixture (for example a polymerisable unsaturated compound in combination with a polymerisation initiator), curing can take place either by exposure to light of a wavelength of 380 to 780 nm (visible light) or light of a wavelength of 780 to 1,200 nm (near infrared).

In principle, the following rule applies: the longer the wavelength, the greater the penetration depth. Consequently, with the use of visible light or light near the infrared spectrum it is also possible to cure layers which comprise further ingredients, for example fillers such as calcium carbonate.

Since in many regards the outer layer of a pipe is subject to particular requirements (for example in relation to mechanical strength, influence of light, hardness, homogeneity), one embodiment of the invention provides for the external circumferential layer of the pipe to be made from a resin cured by exposure to light. This layer can comprise fillers, wherein according to various embodiments a filler content of <10 or <5 weight % is selected. A further embodiment provides for the selection of a resin layer which is free of filler as the external circumferential layer. This resin layer can particularly easily and quickly be cured by exposure to light, for example if it comprises a polymerisable unsaturated compound in combination with a polymerisation initiator.

At a layer thickness of, for example, 2 to 3 mm, a cured layer can be formed in less than 10 minutes. Due to the short curing time, evaporation of monomers, for example styrene evaporation, either does not take place at all, or is considerably reduced when compared to the situation in the state of the art. At the same time, productivity is increased and energy (for example for heating up a curing liquid) is saved.

Quickly thereafter, the construction of further layers can take place, either using the same technology (i.e. curing the resins used by exposure to light) or by means of the known process technology (by exposure to heat)

In the same way as described above, it is possible to also form the internal cover layer of the pipe from a resin layer which has been cured by exposure to light, again if necessary with slight fractions of filler as described, or even without any filler. This results in the same advantages as mentioned above with reference to the external circumferential layer.

To the extent that conventional resin mixtures are used between the internal and external layers, which resin mixtures are cured (or have to be cured) by exposure to heat, this is not relevant in relation to evaporation of monomers, if the internal and external layers are designed according to the invention, in other words if they are already cured and thus prevent evaporation of the monomers. Exposure to radiation of the layers applied within the mould can take place in an easy way by means of a light carried along on the lance by way of which the raw materials are fed into the mould. Such a light can for example be a metal halide light.

In the manufacture of pipes for conveying drinking water it is important that the inside of the pipe comprises a coating which prevents any harmful substances from coming into contact with the drinking water. In the state of the art this requires the use of selected pure resins (polyester resins) which are correspondingly suitable for applications involving drinking water. However, these very resins require a high starting temperature for curing. Here too, the proposition according to the invention provides significant advantages in that the inner layer comprises a material which is effectively curable in a very short time by exposure to light.

As already mentioned, suitable materials can be formed from a polymerisable unsaturated compound in combination with a polymerisation initiator (starter). The above-mentioned polymerisable unsaturated compounds can for example be any of the following resins: unsaturated polyester resin, vinyl ester resin, polyester acrylic acid condensation resin or methacrylic acid condensation resin, polyurethane resin containing ethylenically unsaturated groups, vinyl ester resin containing phosphorus, etc. The polymerisation initiator to be used can for example be an organoboron compound of the formula: 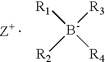
wherein R₁, R₂, R₃ and R₄ each independently can be an if necessary substituted alkyl, aryl, allyl, aralkyl, alkenyl or heterocyclical group or a halogen atom, and Z⁺ representing a cation, wherein the boron compound comprises an acid compound. This acid compound in turn can be a latent acid generating agent which forms an acid by exposure to light and/or heat, for example an organic sulfonium compound.

Although as a rule the maximum thickness of the light-cured layer within the centrifugally moulded plastic pipe is 2 to 3 mm, depending on the filler content greater layer thicknesses (up to 10 mm and beyond) are also possible. In principle the rule applies that the purer the resin the thicker the layer can be in order to be cured exclusively by exposure to light within an acceptable timeframe. It is also possible, parallel to curing by exposure to light, to carry out further hardening methods, for example using peroxide.

A pipe according to the invention comprises at least one resin layer cured by exposure to light; in other words, it is also possible for two or more layers to be cured by exposure to light. These layers can be positioned side-by-side or they can be separated from each other by intermediate layers. The design and composition of the further layers can correspond to those of the state of the art. For example, individual layers can comprise various fractions of glass fibres while other layers are enriched with fillers of various provenance, wherein these layers again can be separated from each other by pure resin layers or resin/sand layers.

A further advantage of curing by exposure to light consists of such curing commencing on the surface if the outer layer is cured by exposure to light, while in the state of the art curing is only carried out by the application of heat after several layers have been applied, with such curing taking place from the inside towards the outside. For this reason also, the curing time for curing by exposure to light is significantly shorter than the curing time for curing by the application of heat.

1. A multilayer plastic pipe produced according to the centrifugal moulding process, comprising at least one layer of a resin which has been cured by exposure to light of a wavelength of 380 nm to 1200 nm.

2. The plastic pipe according to claim 1, whose external circumferential layer comprises a resin which has been cured by exposure to light.

3. The plastic pipe according to claim 1, whose internal layer comprises a resin which has been cured by exposure to light.

4. The plastic pipe according to claim 2 or 3, in which the internal circumferential layer, the external circumferential layer, or both layers comprises/comprise less than 10 weight % of filler.

5. The plastic pipe according to claim 2 or 3, in which the internal circumferential layer, the external circumferential layer, or both layers comprises/comprise less than 5 weight % of filler.

6. The plastic pipe according to claim 2 or 3, in which the internal circumferential layer, the external circumferential layer, or both layers comprises/comprise no fillers.

7. The plastic pipe according to claim 1, in which the resin comprises a polymerisable unsaturated compound in combination with a polymerisation initiator.

8. The plastic pipe according to claim 1, in which the thickness of the resin layer, which layer has been cured by exposure to light, is <4 mm.

9. The plastic pipe according to claim 1, in which the thickness of the resin layer, which layer has been cured by exposure to light, is <2 mm.
